(19) United States
(12) Patent Application Publication
(10) Pub. No.: US 2007/0132389 A1
(43) Pub. Date: Jun. 14, 2007

(54) Plasma display panel

(75) Inventors: Ikuo Ozaki, Miyazaki-shi (JP); Seiki Kurogi, Miyazaki-shi (JP); Kanji Kawano, Miyazaki-shi (JP); Minoru Hasegawa, Nishi-ku (JP); Shigeo Kasahara, Tarumi-ku (JP); Fumiaki Yoshino, Miyazaki-shi (JP)

Correspondence Address: STAAS & HALSEY LLP, SUITE 700, 1201 NEW YORK AVENUE, N.W., WASHINGTON, DC, 20005, US

(73) Assignee: FUJITSU HITACHI PLASMA DISPLAY LIMITED, Miyazaki (JP)

(21) Appl. No.: 11/635,549

(22) Filed: Dec. 8, 2006

(30) Foreign Application Priority Data
Dec. 12, 2005 (JP) 2005-357952
Sep. 14, 2006 (JP) 2006-249681

(51) Int. Cl. H01J 17/49

(52) U.S. Cl. 313/582

(57) ABSTRACT

A plasma display panel comprising at least a blue phosphor layer and a green phosphor layer, the blue phosphor layer containing BaMgAl₁₀O₁₇:Eu particles, Eu containing Eu³⁺, a ratio of Eu³⁺ to Ba at a surface of each BaMgAl₁₀O₁₇:Eu particle being 1.5 or more (atomic ratio: measured by XPS).

### CROSS-REFERENCE TO RELATED APPLICATION

This application is related to Japanese applications Nos. 2005-357952 filed on Dec. 12, 2005 and 2006-249681 filed on Sep. 14, 2006 whose priorities are claimed and the disclosures of which are incorporated by reference in their entirety.

### BACKGROUND OF THE INVENTION

1. Field of the Invention

The present invention relates to a plasma display panel. More particularly, the present invention relates to a plasma display panel including a blue phosphor layer with improved properties and a green phosphor layer.

2. Description of Related Art

Generally, plasma display panels (PDPs) include phosphor layers which emit light beams of three colors, that is, red, blue and green. Combinations of the light beams of the three colors permit light beams of desired colors to be emitted from the PDPs.

Usually, phosphor layers are formed by applying a phosphor paste containing phosphor particles, a binder resin and a solvent onto an predetermined area and firing the resulting coating. Usually used as blue phosphor particles is BaMgAl₁₀O₁₇:Eu, which is referred to generally as a BAM-type phosphor. Note that phosphors are represented by “host material:activator”. In BaMgAl₁₀O₁₇:Eu for example, BaMgAl₁₀O₁₇ in is a host material, and Eu is an activator.

It is known that the above phosphor, BaMgAl₁₀O₁₇:Eu, when used for a blue phosphor layer, is prone to degrade in luminance with time. Japanese Unexamined Patent Publication No. 2005-97599 describes a method of preventing the degradation with time. This publication describes that the degradation can be prevented by controlling the distribution state of Eu²⁺ and Eu³⁺ in the BaMgAl₁₀O₁₇:Eu phosphor particle. More specifically, the publication proposes using, as a blue phosphor material, BaMgAl₁₀O₁₇:Eu phosphor particles, each having a Eu²⁺ concentration decreased at its surface in comparison with that as a whole, in other words, each having a Eu³⁺ concentration increased at its surface to make elimination of oxygen atoms difficult.

The BaMgAl₁₀O₁₇:Eu particles described in the above publication each having a Eu³⁺ concentration increased at its surface, not only suppress the luminance degradation of the blue phosphor layer but also permit good chromaticity.

On the other hand, Japanese Unexamined Patent Publication No. 2004-172091 reports that when BaMgAl₁₀O₁₇:Eu particles are used for a blue phosphor layer in a PDP including red, blue and green phosphor layers, the chromaticity and luminance of the blue phosphor layer are prone to degrade with time. This publication describes that a cause of the degradation is water molecules adsorbed on the green phosphor layer and that the degradation is significant especially when the green phosphor layer contain Zn₂SiO₄:Mn.

### SUMMARY OF THE INVENTION

The present invention provides a plasma display panel comprising at least a blue phosphor layer and a green phosphor layer, the blue phosphor layer containing BaMgAl₁₀O₁₇:Eu particles, Eu containing Eu³⁺, a ratio of Eu³⁺ to Ba at a surface of each BaMgAl₁₀O₁₇:Eu particle being 1.5 or more (atomic ratio: measured by XPS).

Also, the present invention provides a plasma display panel comprising at least a blue phosphor layer and a green phosphor layer, the blue phosphor layer containing BaSrMgAl₁₀O₁₇:Eu particles, Eu containing Eu³⁺, a ratio of Eu³⁺ to Ba and Sr at a surface of each BaSrMgAl₁₀O₁₇:Eu particle being 1.5 or more (atomic ratio: measured by XPS).

Further, the present invention provides a plasma display panel comprising at least a blue phosphor layer and a green phosphor layer, the blue phosphor layer containing BaMgAl₁₀O₁₇:Eu particles, the green phosphor layer containing Zn₂SiO₄:Mn particles, Eu containing Eu³⁺, a ratio of Eu³⁺ to Ba at a surface of each BaMgAl₁₀O₁₇:Eu particle being 1.5 or more (atomic ratio: measured by XPS).

Moreover, the present invention provides a plasma display panel comprising at least a blue phosphor layer and a green phosphor layer, the blue phosphor layer containing BaSrMgAl₁₀O₁₇:Eu particles, the green phosphor layer containing Zn₂SiO₄:Mn particles, Eu containing Eu³⁺, a ratio of Eu³⁺ to Ba and Sr at a surface of each BaSrMgAl₁₀O₁₇:Eu particle being 1.5 or more (atomic ratio: measured by XPS).

These and other objects of the present application will become more readily apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a graph showing the relationships between binding energy and its intensity which is determined by XPS of the blue phosphor, according to Example 1.

FIG. 2 is graph showing the relationships between binding energy and its intensity which is determined by XPS of the blue phosphor, according to Example 1.

FIG. 3 is a graph showing the relationships between heat temperature and quantity of water released from the blue phosphors, according to Example 1.

FIG. 4 is a graph showing the relationships between ratio of Eu³⁺ to Ba of the blue phosphor removed from PDPs after the completion of the PDPs and quantity of water released from the blue phosphor layers, according to Example 2.

FIG. 5 is a graph showing the relationships between ratio of Eu³⁺ to Ba of the PDPs and change amount in chromaticity at the lighting of the PDPs, according to Example 3.

FIG. 6 is a graph showing the relationships between Eu³⁺/Ba ratio of the PDPs and discharge firing voltage at the completion of the PDPs, according to Example 4.

FIG. 7 is a graph showing the relationships between ratio of Eu³⁺ to Ba of the PDPs and rise amount in discharge firing voltage, according to Example 4.

FIG. 8 is a graph showing the relationships between Eu³⁺/Ba ratio of the PDPs and light-emission color CIEy value the blue phosphors at the completion of the PDPs, according to Example 5.

FIG. 9 is a graph showing the relationships between ratio of Eu³⁺ to Ba of the PDPs and change rate in luminance of the green phosphors at the lighting of PDPs, according to Example 6.

FIG. 10 is a perspective schematic view of a PDP.

FIG. 11 is a graph showing the relationships between heat temperature of the blue phosphors and quantity of a released gas, according to Example 7.

FIG. 12A is a graph showing the relationships between heat temperature of the blue phosphors and quantity of water, according to Example 7.

FIG. 12B is a graph showing the relationships between temperature of the blue phosphors and quantity of carbon dioxide, according to Example 7.

FIG. 13 is a graph showing the results of measurements of the blue phosphors (relative values) at the lighting of PDPs, according to Example 8.

### DESCRIPTION OF THE PREFERRED EMBODIMENTS

An object of the present invention is to provide a PDP including a blue phosphor layer made of a blue phosphor ensuring that the blue phosphor layer has excellent properties (chromaticity, luminance and the like) and suppressing changes in the luminance and light-emission color (especially, of the green phosphor layer) and a rise in the discharge firing voltage.

The PDP according to the present invention includes at least a BAM-type blue phosphor layer and a green phosphor layer. The blue phosphor layer is made of a blue phosphor containing BaMgAl₁₀O₁₇:Eu particles or BaSrMgAl₁₀O₁₇:Eu particles. In these particles, Eu consists of Eu²⁺ and Eu³⁺.

Ba and Eu³⁺ (optionally, Sr) extent at a surface of the blue phosphor so that a ratio of Eu³⁺ to Ba or ratio (i.e. Eu³⁺/Ba ratio) of Eu³⁺ to Ba and Sr (i.e. Eu³⁺/(Ba+Sr) ratio) at the surface of each BaMgAl₁₀O₁₇:Eu particles or BaSrMgAl₁₀O₁₇:Eu particles is 1.5 or more (atomic ratio: measured by XPS). The BaMgAl₁₀O₁₇:Eu particles or BaSrMgAl₁₀O₁₇:Eu particles which have the above particular Eu³⁺/Ba ratio or Eu³⁺/(Ba+Sr) ratio, have excellent light emission intensity and light-emission color.

Further, the present inventors have unexpectedly found that when the Eu³⁺/Ba ratio or Eu³⁺/(Ba+Sr) ratio is 1.5 to 2.8, the BaMgAl₁₀O₁₇:Eu particles or BaSrMgAl₁₀O₁₇:Eu particles exert much reduced influences on a phosphor layer other than the blue phosphor layer and on a discharge firing voltage.

Also, the present inventors have unexpectedly found that when the Eu³⁺/Ba ratio or Eu³⁺/(Ba+Sr) ratio is 1.5 to 4.5 and the BaMgAl₁₀O₁₇:Eu particles or BaSrMgAl₁₀O₁₇:Eu particles each have on its surface a coating containing at least silicon oxide or aluminum oxide, they exert much reduced influences on a phosphor layer other than the blue phosphor layer and on a discharge firing voltage, and that the blue phosphor layer, has excellent light emission intensity and light-emission color.

There will be described below the circumstances that led the present inventors to find the above-mentioned numerical ranges.

Taking, for example, BaMgAl₁₀O₁₇:Eu particles, Eu in BaMgAl₁₀O₁₇:Eu consist chiefly of Eu²⁺ which favorably emits light. Meanwhile, Eu³⁺ has a greater number of holes than Eu²⁺ and thus has a greater force to attract O²⁻ in the BaMgAl₁₀O₁₇:Eu particles than Eu²⁺. This means that increasing the concentration of Eu³⁺ at the particle surface permits a strong bonding between Eu and O, resulting in particles less prone to degrade by heat and vacuum ultraviolet radiation. Particles developed as a result of such consideration are presumed as the ones described in Japanese Unexamined Patent Publication No. 2005-97599.

Meanwhile, Japanese Unexamined Patent Publication No. 2004-172091 describes that since the BaMgAl₁₀O₁₇:Eu blue phosphor particles are adversely affected by water adsorbed mainly on the green phosphor and changes their properties, the changes in the properties of the blue phosphor itself can be suppressed by using as the green phosphor an aluminate-type compound on which water is less adsorbable.

However, the present inventors have found that in PDPs including no other phosphor layer than a Zn₂SiO₄:Mn type green phosphor layer, the properties of the green phosphor layer change little, and that in PDPs having a BaMgAl₁₀O₁₇:Eu blue phosphor layer and a Zn₂SiO₄:Mn green phosphor layer arranged adjacent each other, the properties of the green phosphor layer changes greatly, and after eager study of these findings, have noted the following phenomenon in the BaMgAl₁₀O₁₇:Eu particles.

Ba²⁺ and O²⁻ cancel each other out and so do Eu²⁺ and O²⁻, so that the charges are balanced, and the BaMgAl₁₀O₁₇:Eu particles has a neutral polarity. However, increasing the concentration of Eu³⁺ excessively at the particle surface shifts the polarity at the surface greatly to a positive side. The surface with a shifted polarity attracts and adsorbs thereon impurity molecules (for example, water, carbon dioxide and the like) around particles. The adsorbed impurity molecules are released into a discharge space during a discharge to degrade the properties of the adjacent green phosphor layer and raise the discharge firing voltage. This is a totally unexpected matter considering, for example, the statement in Japanese Unexamined Patent Publication No. 2004-172091, that conventionally, impurity molecules, responsible for the degradation in the blue phosphor properties, are considered to come from the green phosphor layer.

The above will be explained more specifically. The thick line in FIG. 3 represents the quantity of water released, from BaMgAl₁₀O₁₇:Eu particles having a Eu³⁺/Ba ratio of 3.38, by heating the particles from room temperature (25° C.) to 1000° C., the quantity measured by a temperature programmed desorption gas analyzing method. Of water released by heating from room temperature to 500° C., a majority is release to the outside by heating during the manufacturing process of the PDP, and thus the water exerts little influences. However, water released by heating from 500° C. to 1000° C., which makes up a relatively great proportion of all the water released, is not released to the outside by the heating during the manufacturing process of the PDP and remains in the particles even after completion of the PDP until a discharge occurs when it is released into the discharge space.

The thin line in FIG. 3 represents the quantity of water released from BaMgAl₁₀O₁₇:Eu particles having a Eu³⁺/Ba ratio of 2.13, by heating the particles from room temperature (25° C.) to 1000° C., the quantity measured by the temperature programmed desorption gas analyzing method. A significantly reduced quantity of water is released from these particles by heating from 500° C. to 1000° C.

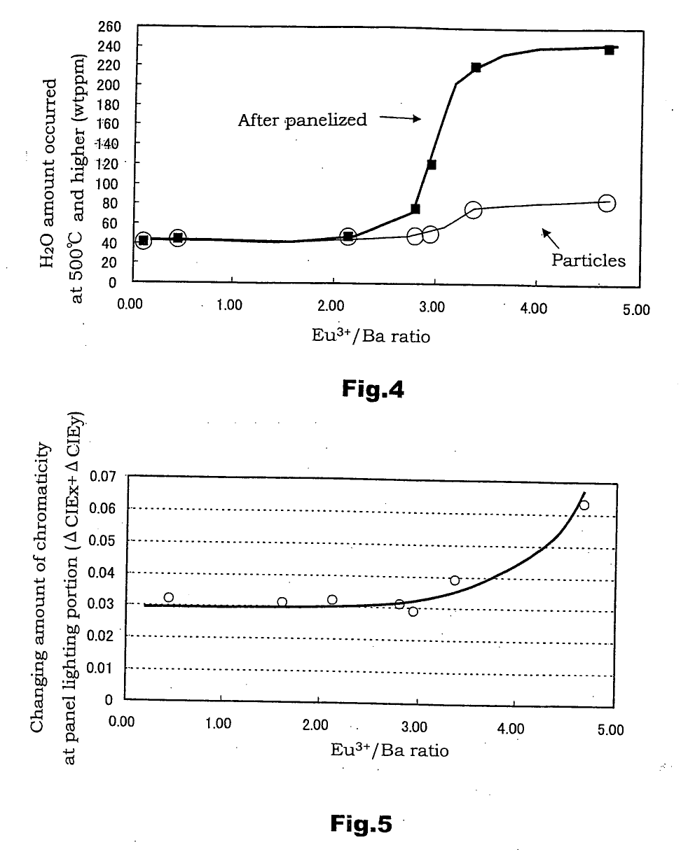

FIG. 4 shows the results of measurements of the quantities of water released, from BaMgAl₁₀O₁₇:Eu particles as a blue phosphor layer with different Eu³⁺/Ba ratios, by heating from room temperature to 1000° C., the measurements made after removal of the BaMgAl₁₀O₁₇:Eu particles from PDPs in an inert gas atmosphere. It can be confirmed that a significantly increased quantity of water is released from a BaMgAl₁₀O₁₇:Eu particles (phosphor particles) with a Eu³⁺/Ba ratio of more than 2.8 by heating from 500° C. to more than 500° C., indicating that a great quantity of water is adsorbed on the particles during the manufacturing process of the panel. This is the reason why the great quantity of water is released into a discharge space during a discharge.

Namely, the present inventors have found that by using for the blue phosphor layer the BaMgAl₁₀O₁₇:Eu particles whose Eu³⁺/Ba ratio is in a predetermined range, the degradation of phosphor layers including the blue phosphor layer by water and adverse influences of the water on the discharge firing voltage can be suppressed, irrespective of materials of a phosphor layer other than the blue phosphor layer, thereby achieving the present invention.

Also, increasing the Eu³⁺/Ba ratio (or Eu³⁺/(Ba+Sr) ratio) makes the blue phosphor layer less prone to degrade. However, increasing this ratio cause a polarity shift at the blue phosphor surface as described above, resulting in an increase in the quantity of impurity molecules to be adsorbed on the blue phosphor surface. The present inventors have found that by coating the particle surface with a material having a neutral polarity, the quantity of impurity molecules to be adsorbed can be reduced. The blue phosphor particles with such a coating have a high Eu³⁺/Ba ratio (or Eu³⁺/(Ba+Sr) ratio), and thus the use of these particles is advantageous in the following points: due to their high Eu³⁺/Ba ratio (or Eu³⁺/(Ba+Sr) ratio, the blue phosphor particles are less prone to degrade during the manufacturing process of the panel. Blue-color light emission with excellent purity is attained when the PDP is lit. And, luminance degradation of the green phosphor and changes in the discharge firing voltage can be suppressed due to the coating. Thus, the PDP obtained has high performance and reliability.

The above will be explained more specifically.

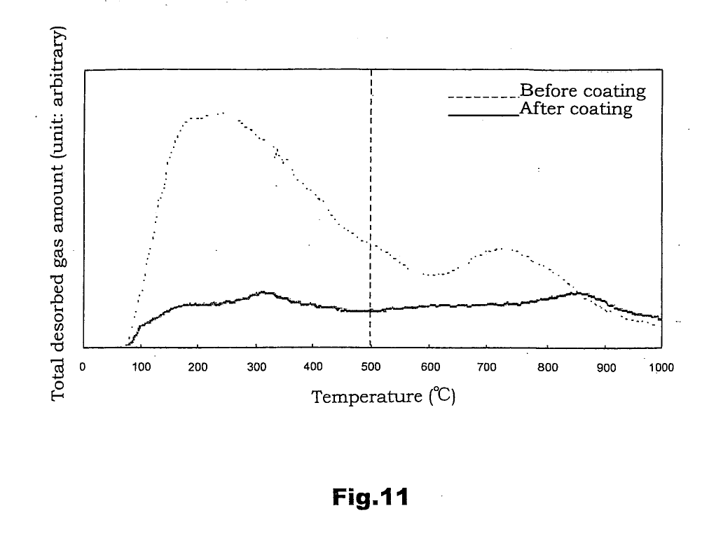

The dashed line in FIG. 11 represents the quantity of a gas desorbed from BaMgAl₁₀O₁₇:Eu particles having a Eu³⁺/Ba ratio of 4.17 by heating the particles from room temperature (25° C.) to 1000° C., the quantity measured by the temperature programmed desorption gas analyzing method, while the thick line represents the quantity of the gas desorbed, from BaMgAl₁₀O₁₇:Eu particles each having a coating containing silicon oxide on its surface and having the same Eu³⁺/Ba ratio of 4.17, by heating the particles from room temperature (25° C.) to 1000° C.

The graph shows that the quantity of the gas desorbed from the BaMgAl₁₀O₁₇:Eu particles without coatings on the surfaces has two peaks, one at a value below 500° C. and the other at a value above 500° C. On the other hand, the quantity of the gas desorbed from the BaMgAl₁₀O₁₇:Eu particles each having a coating on the surface is much lower than that of the gas from the BaMgAl₁₀O₁₇:Eu particles having no coating. Causes of this are considered to be:

(1) By heating in a predetermined temperature range at the formation of the coatings, impurity molecules capable of being removed by the heating in the range were removed.

(2) The ability of the coating to adsorb impurity molecules thereon was much lower than that of the blue phosphor particles, so that impurity molecules around the coating is difficult to adsorb on the coating.

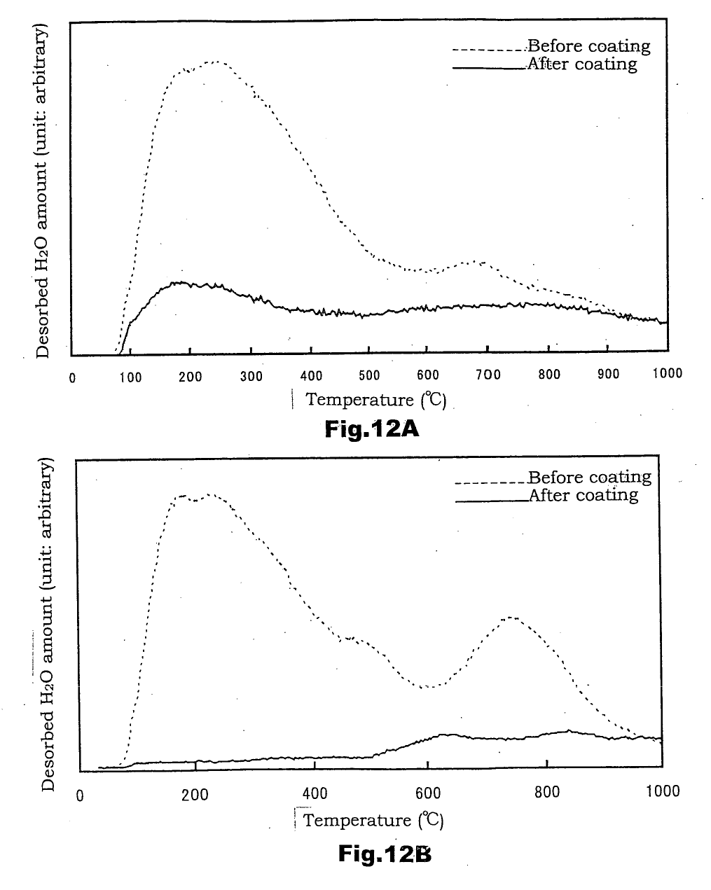

FIGS. 12A and 12B respectively show changes, before and after the formation of the coatings, in the quantities of desorbed gases, that is, H₂O and CO₂, which constitute a great majority of the impurity molecules. These figures, like FIG. 11, indicate the effect of reducing the quantities of impurity molecules. FIG. 11 indicates that the gas generated by heating from 500° C. to higher than 500° C., that is, by heating at high temperatures, was removed. The gas removed at these temperatures is a gas difficult to remove by a usual heating treatment during the manufacturing process of a panel. In this sense, the effect of reducing the quantity of the gas desorbed from the phosphor layer was of a great significance. Further, the coating, which prevents the gases from being re-adsorbed, makes it difficult for the gases generated from a phosphor other than the blue phosphor to be adsorbed on the blue phosphor during the manufacturing process of a panel.

From the above, the present inventors have found that increasing the Eu³⁺/Ba ratio (or Eu³⁺/(Ba+Sr) ratio) makes the blue phosphor layer less prone to degrade, and coating the particle surface permits a reduction in the quantity of impurity molecules to be adsorbed. As a result, the blue phosphor particles are made less prone to degrade during the manufacturing process of the PDP. Blue-color light emission with excellent purity is attained when the PDP is lit. And, luminance degradation of the green phosphor and changes in the discharge firing voltage can be suppressed.

In the present invention, BAM-type blue phosphor particles are used which are selected to have a Eu³⁺/Ba of 1.5 or more. BAM-type blue phosphor particles having a Eu³⁺/Ba of less than 1.5 are not preferable since a blue phosphor layer containing such phosphor particles is more prone to degrade. BAM-type blue phosphor particles without coatings to be mentioned later on the surfaces preferably have a Eu³⁺/Ba ratio of not more than 2.8. BAM-type blue phosphor particles having a Eu³⁺/Ba of more than 2.8 adsorb thereon a great quantity of impurity molecules, especially water (H₂O) and carbon dioxide (CO₂), so that a phosphor layer other than the blue phosphor layer, especially the green phosphor layer, can possibly be rendered more prone to degrade.

BAM-type blue phosphor particles with coatings to be mentioned later on the surfaces preferably have a Eu³⁺/Ba ratio of not more than 4.5.

Ba and Eu as constituents of BaMgAl₁₀O₁₇:Eu may be contained in any proportions in the BaMgAl₁₀O₁₇:Eu as long as desired properties can be attained. Further, Sr may be substituted in part for Ba. Such particles can be represented by BaSrMgAl₁₀O₁₇:Eu. A proportion of Sr to be substituted for a part of Ba, which is represented as a molar ratio of Sr/(Ba+Sr), is preferably 0.05 or more, more preferably 0.1 to 0.2.

In the case of the present particles, the Eu³⁺/(Ba+Sr) ratio at a surface of each particle is 1.5 or more. The Eu³⁺/(Ba+Sr) ratio of less than 1.5 is not preferable since in such a case, the blue phosphor layer is more prone to degrade. In the case of particles without coatings to be mentioned later on the surfaces, the Eu³⁺/(Ba+Sr) ratio is preferably not more than 2.8. If the Eu³⁺/(Ba+Sr) is more than 2.8, a great quantity of impurity molecules could possibly be adsorbed on the blue phosphor layer, making a phosphor layer other than the blue phosphor layer more prone to degrade.

In the case of particles with coatings to be mentioned later on the surfaces, the Eu³⁺/Ba ratio is preferably not more than 4.5.

It is preferable that the total quantity of water released from the BaMgAl₁₀O₁₇:Eu particles or BaSrMgAl₁₀O₁₇:Eu particles by heating from 500° C. to 1000° C. is 20% or less based on the weight of the total quantity of water (mass number: 18) released from these particles by heating from room temperature to lower than 500° C., and that the total quantity of water released from these particles by heating from 500° C. to higher than 500° C. is 80 wtppm or less (based on the weight of the blue phosphor). The above quantity of the water released from the particles of the present invention is much less, in comparison with 200 ppm or more of water retained by conventional particles in a panel, since in the conventional particles, water is adsorbed on the particles during the manufacturing process of the panel, in addition to water originally contained in the particles. As seen, the present invention can suppress the release of water into a discharge space, and thus the degradation in the properties of phosphor layers and a rise in the discharge firing voltage.

The coating is not particularly limited if it is made of a material that permits the coating to have a substantially neutral polarity at its surface. As such a coating, a silicon oxide coating, an aluminum oxide coating and the like may be mentioned. The silicon oxide coating and the aluminum oxide coating are highly transmissive, if their thicknesses do not exceed a value, to vacuum ultraviolet radiation, radiation acting to excite phosphors, and thus, by using one of these coatings, it is possible to avoid a decrease in the luminance of phosphor layers, which otherwise would be caused by the vacuum ultraviolet radiation being blocked. Of these coatings, the silicon oxide coating, which is the more highly transmissive, is preferable. Here, the coating preferably has a transmittance of 80% or more to the vacuum ultraviolet radiation. Note that the above transmittance was determined by a vacuum ultraviolet radiation photoelectron system manufactured by Nippon Bunkoh Ltd.

The coating preferably has a thickness of 1 nm to 20 nm.

Usually, the total quantity of gases desorbed from the BaMgAl₁₀O₁₇:Eu particles or BaSrMgAl₁₀O₁₇:Eu particle by heating from 500° C. to 1000° C. is smaller than the total quantity of the gases desorbed from the above particles by heating from room temperature to 500° C. The blue phosphor particles with coatings, on the other hand, permit a significant reduction in the total quantity of the gases desorbed in the overall temperature range. Table 1 shows the results of measurements of the quantities of the gases desorbed from the BaMgAl₁₀O₁₇:Eu particles before and after the formation of the coatings (the quantities being represented as relative values obtained assuming that the total quantity of the gases desorbed before the formation of the coatings is 100%).

TABLE 1

| | Quantity of gas desorbed (%) | |
|---|---|---|
| | Before formation of | After formation of |
| Heating temperature | coatings | coatings |
| Room temperature to lower | 69 | 17 |
| than 500° C. | | |
| 500 to 1000° C. | 31 | 19 |
| Room temperature to | 100 | 36 |
| 1000° C. | | |

Table 1 shows that the BaMgAl₁₀O₁₇:Eu particles with coatings are different from conventional ones without coatings in that the total quantity of gases desorbed from the particles from 500° C. to 1000° C. is substantially the same as the total quantity of the gases desorbed from room temperature to lower than 500° C. This is a feature specific to the present invention. Also, the reduction in the quantity of the gases generated by heating from 500° C. to 1000° C. means that the present invention ensures that the adsorbed gases that are difficult to remove by a usual manufacturing process of a PDP can be removed before the manufacture of the PDP. In this sense, the effect of reducing the quantity of gases to be desorbed in PDP from the phosphor layer is of a great significance.

The reduction due to the coating in the quantity of gases adsorbed on the blue phosphor means a reduction in the ability of the blue phosphor to adsorb thereon the gases generated from a phosphor other than the blue phosphor during the manufacturing process of a panel.

As having been described above, the PDP that uses as the blue phosphor the phosphor particles with coatings permits a significant reduction in the quantity of gases to be adsorbed on the blue phosphor particles. Consequently, the present invention can suppress the release of gases (for example, water) from the blue phosphor into the discharge space, thereby suppressing degradations in the properties of phosphor layers and a rise in discharge firing voltage.

The BaMgAl₁₀O₁₇:Eu particles (or BaSrMgAl₁₀O₁₇:Eu particles) may be obtained by, for example, the following known method. First, BaCO₃, SrCO₃, MgCO₃, Al₂O₃ and Eu₂O₃ as materials are weighed to be in a desired atomic ratio, and then mixed together. Here, the ratio between the number of mole of Ba and the number of mole of Eu (or between the total number of mole of Ba and Sr and the number of mole of Eu) is set according to a desired ratio in phosphor between the quantity of Ba (or total quantity of Ba and Sr) and the quantity of Eu to be substituted for Ba (or for Ba and Sr). Then, a proper quantity of flux is added to the mixture and mixed with a ball mill. After that, the resulting mixture is sintered. Usually, the sintering is performed under a reducing atmosphere (for example, under a hydrogen atmosphere or under an atmosphere of a mixture of hydrogen and nitrogen). At this time, the sintered body of phosphor has a predominance of Eu²⁺ over Eu³⁺ at the surface. The sintered body is milled into particles and classified. Then, the particles are heated under an inert gas atmosphere (for example, under a nitrogen atmosphere) to convert a predetermined quantity of Eu²⁺ at the surfaces to Eu³⁺ for control of the quantity of Eu³⁺.

The sintering conditions are adjusted depending on the kinds of elements used, and generally, the sintering is preferably performed at 1300 to 1600° C. for 1 to 10 hours under atmospheric pressure. To lower the sintering temperature, a halide such as AlF₃, MgF₂, LiF, NaF or the like, or a reaction accelerating agent made of a low melting point oxide such as B₂O₃, P₂O₅ or the like may be added in a quantity that does not hinder the effects of the present invention. The above heating treatment under an inert gas atmosphere is preferably performed at 700 to 1300° C. for 0.5 to 5 hours under atmospheric pressure.

The method of forming the coatings on the particle surfaces is not particularly limited, and may be, for example, the following method, which is an ordinary method.

If the desired coatings are a silicon oxide coating for example, blue phosphor particles are sufficiently washed, and then immersed in a solution in an organic solvent of a silicon polymer represented by the molecular structural formula: SiHaNb (a=1 to 3, b=0 or 1) or the like. Then, the solution containing the phosphor particles is homogeneously stirred, and after that, left stand for a predetermined period. Subsequently, the phosphor particles are separated from the solution by filtration, washed, and dehydrated, followed by drying. Then, the phosphor particles are heated at a predetermined temperature (preferably 600° C. or lower) under an atmosphere containing oxygen, to obtain coatings.

The blue phosphor layer may be made of BaMgAl₁₀O₁₇:Eu particles or BaSrMgAl₁₀O₁₇:Eu particles alone, but may contain other known blue phosphor particles as well if they do not hinder the effects of the present invention.

The green phosphor layer is not particularly limited, and may be any layer made of a known green phosphor. Particularly, the green phosphor layer preferably contains Zn₂SiO₄:Mn particles, the luminance and the chromaticity of which are well balanced on a high level.

The red phosphor layer is not particularly limited, and may be any layer made of a known red phosphor.

In the above explanations, the concentrations of Ba, Sr, Eu²⁺ and Eu³⁺ at the particle surface are calculated based on photoelectron energy spectrum measured by XPS (X-ray photoelectron spectroscopy). In XPS (manufactured by Shimadzu/Kratos, AXIS-HS), the particle surface is irradiated with characteristic X-radiation having an energy of 1486.6 eV under the conditions of a tube voltage of 15 kV and a tube current of 15 mA, to measure the energy of photoelectrons jumping out of the particle surface. The energy of the characteristic X-radiation, with which the particle surface has been irradiated, is subtracted from the measured energy of the photoelectrons, to determine a binding energy, which is then plotted in a graph.

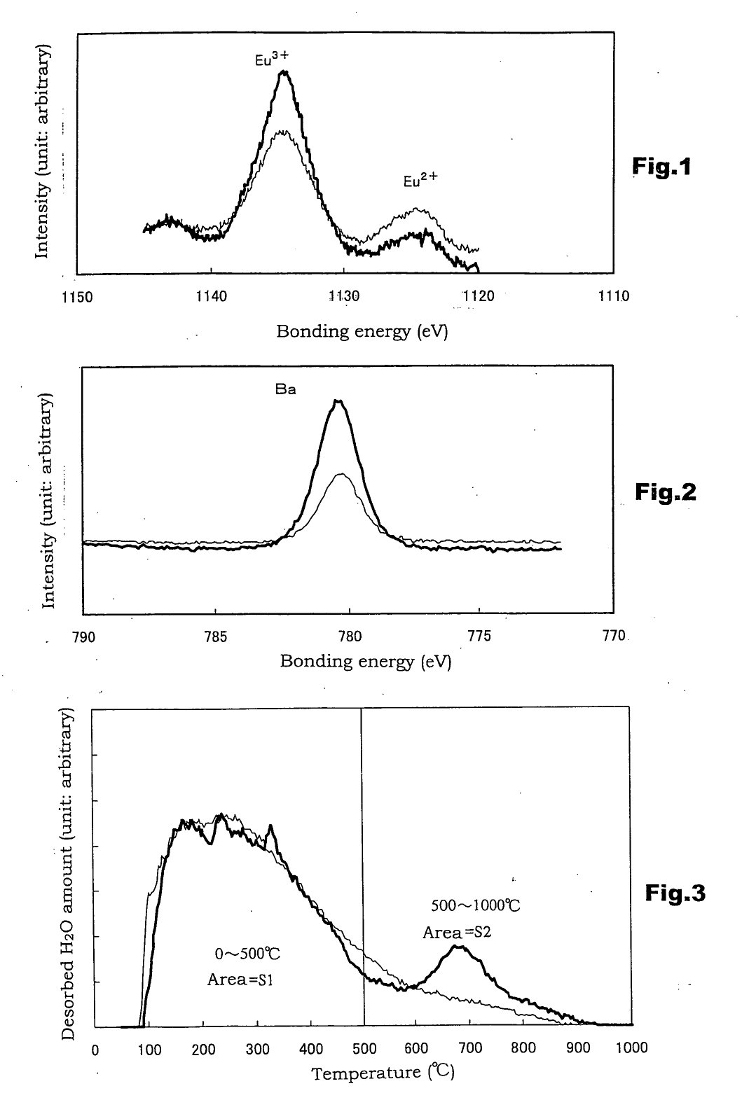

Under the above conditions of the tube voltage of 15 kV and the tube current of 15 mA, the concentrations of Ba, Sr, Eu²⁺ and Eu³⁺ to be calculated are usually those of the atoms present in an area extending from the particle surface to the depth of several nanometers. Throughout the present specification, the term “particle surface” refers to a particle area as defined above. In the XPS, relative sensitive factors of the elements are specified, so that the respective concentrations of Eu²⁺, Eu³, Ba and Sr at the particle surface can be determined based on the specified relative sensitive factors. For example, FIGS. 1 and 2 show the results of calculations of the respective binding energies of Eu²⁺, Eu³⁺ and Ba. The atomic ratio at the particle surface can be calculated from an intensity ratio of three peaks respectively corresponding to Eu²⁺, Eu³⁺ and Ba (i.e., represented by a proportion of areas of the peaks shown in FIG. 1 or 2). Note that the depth in the particle to be reached by the X ray energy varies depending on the energy of excitation light. Thus, the area referred to as “particle surface” may extend to farther than the depth of several nanometers.

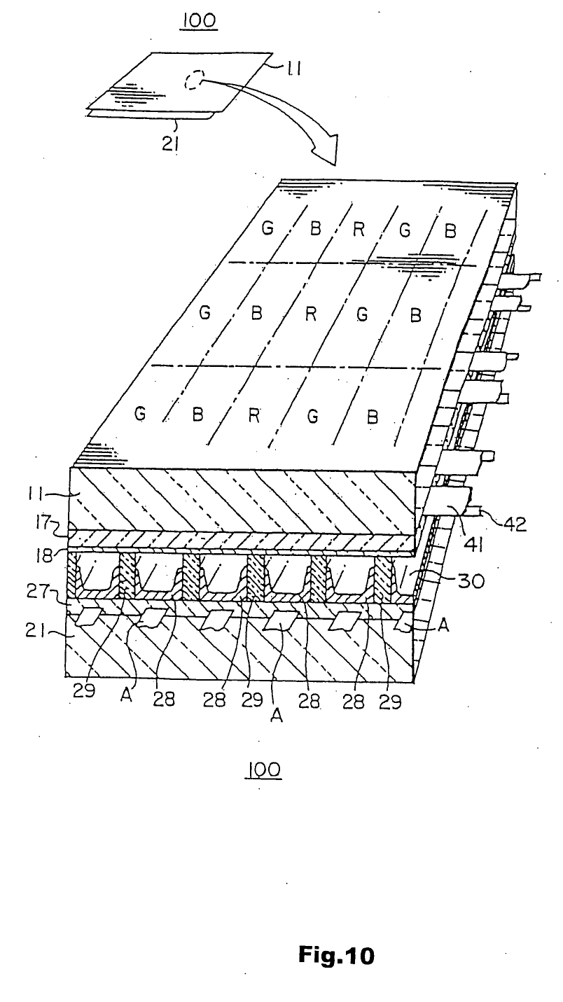

Next, an example of a PDP, to which the present invention is applicable, will be described referring to FIG. 10.

FIG. 10 shows a three-electrode AC-type surface discharge PDP. PDPs to which the present invention is applicable are not limited to PDPs of this type, and the present invention is applicable to any types of PDPs including a phosphor, such as AC- and DC-type PDPs, as well as reflective and transmissive type PDPs.

The PDP 100 of FIG. 10 includes a front substrate and a rear substrate.

The front substrate generally has a front substrate 11; a plurality of display electrodes formed on the front substrate 11; a dielectric layer 17 covering the display electrodes; and a protective layer 18 formed on the dielectric layer 17 and exposed to discharge spaces.

The substrate 11 is not particularly limited, and may be a glass substrate, a quartz substrate or the like.

The display electrode is formed of a transparent electrode 41 of, for example, ITO. Further, the display electrode is formed, for the purpose of a reduction in its resistance, of a transparent electrode 41 and a bus electrode (for example, three-layer structure of Cr/Cu/Cr) 42 formed on the transparent electrode 41.

The dielectric layer 17 is made of a material used conventionally for PDPs. More specifically, the dielectric layer 17 may be formed by applying a paste of a low melting point glass and a binder onto the substrate, followed by firing.

The protective layer 18 is provided for protecting the dielectric layer 17 from damages caused by collision of ions generated by display discharges and for reducing a discharge firing voltage by releasing secondary electrons. The protective layer 18 is made of, for example, MgO, CaO, SrO, BaO or the like.

The rear substrate generally has a rear substrate 21, a plurality of address electrodes A formed on the rear substrate to cross the display electrodes; a dielectric layer 27 covering the address electrodes A; barrier ribs 29 formed on the dielectric layer 27 between the adjacent address electrodes A; and phosphor layers 28 formed between the adjacent barrier ribs 29 to cover their wall surfaces.

The substrate 21 and the dielectric layer 27 may be made of the same materials as those of the substrate 11 and dielectric layer 17 of the front substrate.

The address electrodes A may be made of a metal layer such as Ag, Al or the like, or may have a three layer structure of Cr/Cu/Cr.

The barrier ribs 29 may be formed by applying a paste of a low melting point glass and a binder onto the dielectric layer 27, drying the resulting film and cutting by sandblasting. Alternatively, when a photosensitive resin is used as the binder, the barrier ribs 29 may be formed by exposure via a mask in desired pattern and development, followed by firing.

In FIG. 10, the phosphor layers 28 of red (R), green (G) and blue (B) are formed between the adjacent barrier ribs 29. The present invention is applicable to the phosphor layers 28 of blue (B). Note that conventionally, a blue phosphor layer and a green phosphor layer are formed adjacent each other as shown in FIG. 10. The method of forming the phosphor layers 28 is not particularly limited, and may be a known method. For example, the phosphor layers 28 may be formed by applying a binder solution paste dispersing phosphor particles between the adjacent barrier ribs 29, followed by firing in an atmosphere of air After that, the front substrate and the rear substrate are disposed in opposed relation so that the display electrodes (41, 42) cross the address electrodes A, and a discharge gas is charged into the discharge spaces defined by the barrier ribs, to obtain the PDP 100.

### EXAMPLES

The present invention will now be described by way of examples. However, the present invention is not limited to these examples.

### Example 1 (Manufacture of Particles and Measurement of the Quantity of Water)

BaCO₃, MgCO₃, Al₂O₃ and EU₂O₃ were weighed to be in a desired atomic ratio, and then mixed together for three hours. Here, the ratio between the number of mole of Ba and the number of mole of Eu was set according to a desired ratio in phosphor between the quantity of Ba and the quantity of Eu to be substituted for Ba. After that, the resulting mixture was sintered at 1500° C. for 5 hours in an atmosphere of a gas mixture of hydrogen and nitrogen. The resulting sintered body of phosphor was milled and classified to obtain particle Samples. Then, part of the particle Samples were heated in an inert gas atmosphere (for example, nitrogen atmosphere) to convert a predetermined quantity of Eu²⁺ at their surfaces to Eu³⁺. In this manner, eight BaMgAl₁₀O₁₇:Eu phosphor particle Samples with different Eu³⁺/Ba ratios were obtained.

Table 2 below shows the relationship of the Samples with their Eu³⁺/Ba ratios.

TABLE 2

| Sample No. | Eu (III)/Ba ratio |
|---|---|
| 1 | 0.11 |
| 2 | 0.45 |
| 3 | 1.62 |
| 4 | 2.13 |
| 5 | 2.81 |
| 6 | 2.95 |
| 7 | 3.38 |
| 8 | 4.67 |

FIG. 1 shows the intensities of the binding energies, determined by XPS, of Eu (Eu²⁺ and Eu³⁺) of Sample Nos. 4 and 7 listed in Table 2. FIG. 2 is the intensities of the binding energies, determined by XPS, of Ba of Sample Nos. 4 and 7. In these figures, the thick line represents Sample No. 7 and the thin line represents Sample No. 4. The results in FIGS. 1 and 2 indicate that the Eu³⁺/Ba ratios at the particle surfaces can be determined.

Next, FIG. 3 shows the results of measurements made, by the temperature programmed desorption gas analyzing method, of the quantities of water (mass number: 18) released from Sample Nos. 4 and 7 by heating these Samples from room temperature (about 25° C.) to 1000° C. In this figure, the thick line represents Sample No. 7 in which the S2/S1 area ratio is 0.20 or more, while the thin line represents Sample No. 4 in which the S2/S1 area ratio is less than 0.20. With respect to a phosphor having a Eu³⁺/Ba ratio of 2.8 and less, FIG. 3 indicates that the quantity of water released from this phosphor has no peak at temperatures ranging from 500 to 1000° C., and that the total quantity of the water released from this phosphor by heating from 500 to 1000° C. is 20% or less based on the weight of the total quantity of water released by heating from room temperature to lower than 500° C.

PDPs of the type shown in Table 10 were produced by incorporating therein respectively eight phosphor Samples with different Eu³⁺/Ba ratios as shown in Table 2, and various experiments were made using the PDPs.

### Example 2 (Measurements of the Quantities of Waters Present in the Respective PDPs)

The PDPs were taken apart in an inert gas atmosphere to remove the blue phosphors from their substrates, and the quantities of water released from these blue phosphor Samples by heating these phosphor Samples from room temperature to 1000° C. were measured by the temperature programmed desorption gas analyzing method. FIG. 4 shows the results of these measurements, together with the results of measurements of the quantities of water originally contained in the phosphor Samples. FIG. 4 indicates that increasing the Eu³⁺/Ba ratio to more than 2.8 causes a significant increase in the quantity of water originally contained in a phosphors and the quantity of water released from phosphors removed from PDPs.

### Example 3 (Changes with Time in the Chromaticities of the PDPs)

The initial chromaticities of the PDPs were measured, and then the chromaticities thereof after lighting of the PDPs for a predetermined period were measured. FIG. 5 shows the results of calculations of the differences each between initial chromaticity and chromaticity after the lighting. The differences between initial chromaticity and chromaticity after the lighting are given as the sum of a difference in CIEx value and a difference in CIEy value. FIG. 5 indicates that increasing the Eu³⁺/Ba ratio to more than 2.8 causes a significant difference between chromaticities before and after lighting, that is, a severe degradation with time.

### Example 4 (Discharge Firing Voltages Immediately After Completion of PDPs and Changes in Discharge Firing Voltages After Lightening of the PDPs)

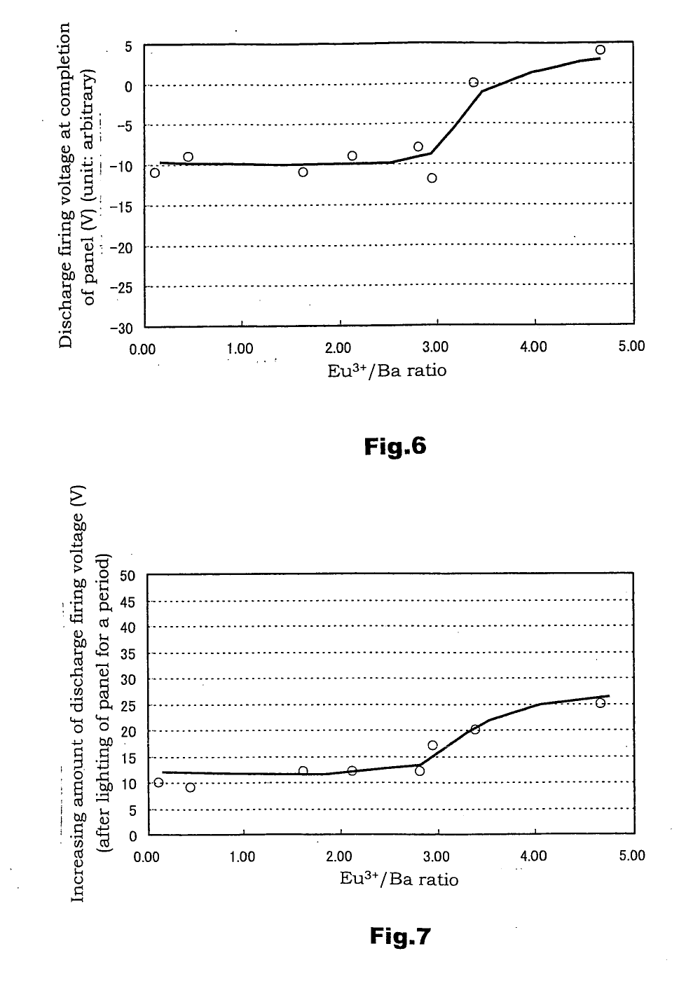

Discharge firing voltages immediately after completion of the PDPs were measured. The results are shown in FIG. 6. Next, discharge firing voltages after lighting of the PDPs for a predetermined period were measured. By subtracting the former discharge firing voltage from the latter discharge firing voltage, a rise in discharge firing voltage was determined. The results are shown in FIG. 7. FIG. 6 indicates that increasing the Eu³⁺/Ba ratio to more than 2.8 causes a significant raise in the discharge firing voltage after lighting of the PDP even immediately after completion thereof. FIG. 1 indicates that increasing the Eu³⁺/Ba ratio to more than 2.8 causes the rise in discharge firing voltage by lighting of the PDPs, that is, a severe degradation with time.

### Example 5 (Measurements of the CIEy Values of the Blue Phosphors Immediately After Completion of the PDPs)

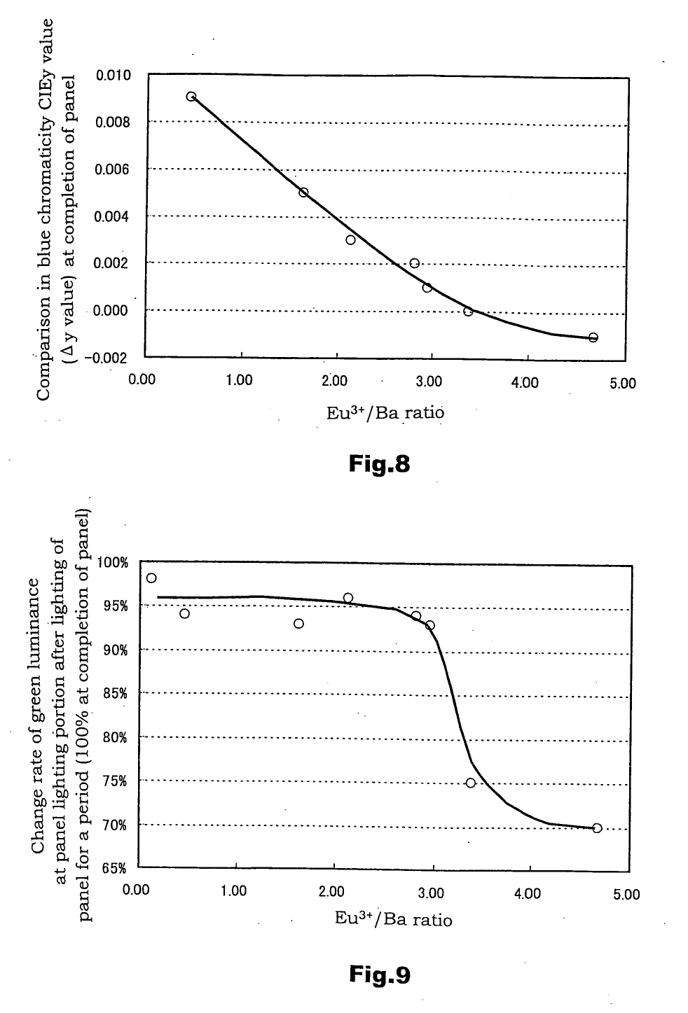

FIG. 8 shows the results of measurements of chromaticity CIEy values indicative of states of light-emission colors of blue cells of the PDPs at the light emission. The axis of ordinate of FIG. 8 represents the difference in CIEy value of Samples 2 to 8 from Sample No. 7. The axis is based on a CIEy value of 0.055 to 0.065. FIG. 8 indicates that the Eu³⁺/Ba ratio to 1.5 or more permits a desired CIEy value (0.070 or less) for a blue phosphor even if the CIEy value is increased.

### Example 6 (Changes with Time in the Luminances of the Green Phosphors of the PDPs)

PDPs respectively including Zn₂SiO₄:Mn-type green phosphors in combination with the eight blue phosphor Samples listed in Table 2 were prepared. The luminances of the green phosphors were measured twice each, that is, after initial aging and after lighting both blue and green cells in each PDP for a predetermined period. FIG. 9 shows the relationship between change in luminance with time and Eu³⁺/Ba ratio. The axis of ordinate of FIG. 9 represents a ratio of luminance after lighting to luminance after aging, in which the later luminance is assumed as 100%. FIG. 9 indicates that increasing the Eu³⁺/Ba of a BAM-type blue phosphor to more than 2.8 causes a reduction in the luminance of a Zn₂SiO₄:Mn type green phosphor, that is, a severe degradation with time.

Here, a discussion will be made on a factor that affects the Eu³⁺/Ba ratio of the above-mentioned BAM-type blue phosphor.

As described above, it is presumed that excessively increasing the ratio of Eu³⁺ to Ba in the BAM-type blue phosphor layer permits a strong bonding by a interatomic energy, but it also causes an increase in the ability to have adsorb thereon impurities around it, such as water, and thus unexpected water contained in the blue phosphor after completion of the PDP, despite sufficient care to prevent water from remaining during the manufacturing process of the PDP. The results in FIG. 4 are evidence that supports this. Release of the remaining water by electric discharge gives an adverse influence on surfaces of a phosphor layer arranged adjacent to the blue phosphor layer and of a protective layer which are sensitive to water.

From the experimental results above, it is noted that the BAM-type blue phosphor layer is preferably selected to have a Eu³⁺/Ba of 2.8 or less when a phosphor and a protective layer are made of material with properties susceptible to degradation by water. Also, it is effective to provide a coating of material with repellency to the surface of the blue phosphor layer.

### Example 7 (Phosphor Particles with Coatings)

BaMgAl₁₀O₁₇:Eu phosphor particles were prepared in the same manner as in Example 1, except that the Eu³⁺/Ba ratio was set to 4.17. The phosphor particles were named Sample No. 9. Silicon oxide coatings were formed on the phosphor particles as Sample No. 9 in the following manner.

First, the phosphor particles as Sample No. 9 were washed enough with deionized water, and then immersed in a 0.2 wt % silicone polymer solution in xylene. The quantity of the silicone polymer solution was five times the quantity of the phosphor particles on a weight basis. After the immersion, the silicone polymer solution was stirred for about 30 minutes so that the phosphor particles were homogeneously dispersed in the solution. Then, the phosphor particles were separated from the solution by filtration. The phosphor particles separated was dried at 150° C. to evaporate and remove the solvent thereon. After that, the phosphor particles were heated at 500° C. in the air for 1 hour to obtain blue phosphor particles having silicon oxide coatings.

Cutting these particles and observing their cross sections found that the coating had a thickness of about 5 nm. The particles were named Sample No. 10.

FIG. 11 shows the results of measurements, by the temperature programmed desorption gas analyzing method, of the total quantities of a gas desorbed from Samples Nos. 9 and 10, respectively, by heating these Samples from room temperature (about 25° C.) to 1000° C. FIGS. 12A and 12B show the results of measurements, made in the same manner as above, of the quantities of water and carbon dioxide desorbed from these Samples.

In FIGS. 12A and 12B, the dashed line represents Sample No. 9, and the thick line represents Sample No. 10. These figures indicate that each of the quantities of the gases desorbed from Sample No. 9 whose Eu³⁺/Ba ratio was as high as 4.17 had a peak at a temperature blow 500° C. and a peak at a temperature above 500° C., and that the quantities of the gases desorbed from Sample 9 having coatings were much smaller than those of the gases from Sample 10 that had no coatings, presumably for the following reasons: A heat treatment at the formation of the coatings removed the gases capable of being removed by the heat treatment. And the ability of the silicon oxide coating to have the gases adsorbed thereon was much lower than that of the blue phosphor surface having a high Eu³⁺/Ba ratio, and thus the gases around are difficult to adsorb on the silicon oxide coating.

In the same manner as in Example 6, measurements were made of the percentages of changes with time in luminance of green phosphors in PDPs that used Sample Nos. 9 and 10, respectively. A green phosphor used in combination with Sample No. 9 remained unchanged by 72% in luminance, while a green phosphor used in combination with Sample No. 10 remained unchanged by 95% in luminance. This indicates that a phosphor with a coating can suppress change with time in luminance to a much greater extent than a phosphor without a coating.

As described above, desorption of water from a blue phosphor by electric discharge adversely affects adjacent phosphors and a protective layer surface which are sensitive to water. However, if the blue phosphor has a coating on its surface, the water adsorption on the blue phosphor surface can be suppressed due to the coating even if the ratio of Eu³⁺ to Ba in the BAM-type blue phosphor is excessive. It is presumed that this permits a significant reduction in the quantity of water in the blue phosphor when the PDP is completed. The results in FIG. 11 are evidence that supports this.

The above experimental results show that a BAM-type blue phosphor with a coating ensures a PDP with desired properties even if the Eu³⁺/Ba ratio of the blue phosphor is relatively high.

### Example 8 (Measurements of the Blue Phosphor Luminance of a PDP)

The luminances of blue phosphors in PDPs that used Samples Nos. 1 to

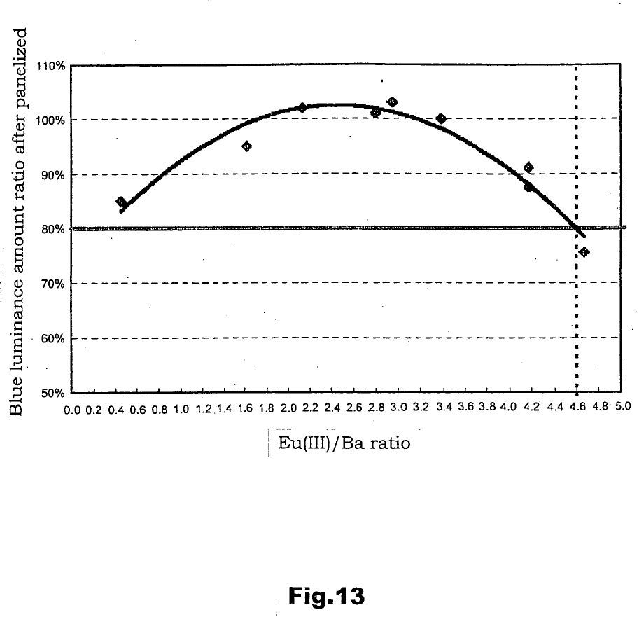

9 were measured by lighting blue cells of each PDP. FIG. 13 shows the results. In order to obtain a blue phosphor luminance sufficient for a PDP, it is desired that the relative quantity of light to be emitted should be 80% or more, based on the quantity of light emitted when the Eu³⁺/Ba ratio is 2.0 to 3.0. FIG. 13 shows that it is noted that the 80% or more of relative quantity of light to be emitted can be realized when the Eu³⁺/Ba ratio is 4.5 or less.

The PDP of the present invention includes at least the blue phosphor layer and the green phosphor layer, the blue phosphor layer having excellent properties and containing either the BaMgAl₁₀O₁₇:Eu particles whose Eu³⁺/Ba ratio is in a predetermined range or the BaSrMgAl₁₀O₁₇:Eu particles whose Eu³⁺/(Ba+Sr) ratio is in a predetermined range. In the PDP of the present invention, (1) changes, caused by the BaMgAl₁₀O₁₇:Eu particles or BaSrMgAl₁₀O₁₇:Eu particles, in the properties of a phosphor layer other than the blue phosphor layer (especially, the green phosphor layer), (2) a discharge firing voltage, and (3) a rise in the voltage after lighting of the PDP for a predetermined period can be suppressed.

Especially, when the green phosphor contains Zn₂SiO₄:Mn, the luminance and the chromaticity of which are well balanced on a high level, changes in the properties of the green phosphor layer can be suppressed to a greater extent.

Further, when the total quantity of water released from the BaMgAl₁₀O₁₇:Eu particles or BaSrMgAl₁₀O₁₇:Eu particles by heating from 500° C. to 1000° C. is 20% or less of the total quantity of water (mass number: 18) released from these particles by heating from room temperature to lower than 500° C., and when the total quantity of water (mass number: 18) released from these particles by heating from 500° C. to higher than 500° C. is 80 wtppm or less (based on the weight of the blue phosphor), changes in the properties of a phosphor layer other than the blue phosphor layer (especially, the green phosphor layer), increase of a discharge firing voltage, and a rise in the voltage at the lighting of the panel can be suppressed.

Also, when the BaMgAl₁₀O₁₇:Eu particles or BaSrMgAl₁₀O₁₇:Eu particles each have on its surface the coating containing at least silicon oxide, the blue phosphor layer has more excellent properties.

What is claimed is:

1. A plasma display panel comprising at least a blue phosphor layer and a green phosphor layer, the blue phosphor layer containing BaMgAl₁₀O₁₇:Eu particles, Eu containing Eu³⁺, a ratio of Eu³⁺ to Ba at a surface of each BaMgAl₁₀O₁₇:Eu particle being 1.5 or more (atomic ratio: measured by XPS).

2. The plasma display panel of claim 1, when the total quantity of water (mass number: 18) released from the BaMgAl₁₀O₁₇:Eu particles by heating from 500° C. to 1000° C. is 20% or less based on the weight of the total quantity of water released from these particles by heating from room temperature to lower than 500° C., and when the total quantity of water released from these particles by heating from 500° C. to higher than 500° C. is 80 wtppm or less (based on the weight of the blue phosphor).

3. The plasma display panel of claim 1, wherein the BaMgAl₁₀O₁₇:EU particles have a coating containing silicon oxide or aluminum oxide, the coating has a substantially neutral polarity at its surface.

4. The plasma display panel of claim 3, wherein the ratio of Eu³⁺ to Ba is 1.5 to 4.5.

5. The plasma display panel of claim 1, wherein the ratio of Eu³⁺ to Ba is 1.5 to 2.8.

6. A plasma display panel comprising at least a blue phosphor layer and a green phosphor layer, the blue phosphor layer containing BaSrMgAl₁₀O₁₇:Eu particles, Eu containing Eu³⁺, a ratio of Eu³⁺ to Ba and Sr at a surface of each BaSrMgAl₁₀O₁₇:Eu particle being 1.5 or more (atomic ratio: measured by XPS).

7. The plasma display panel of claim 6, when the total quantity of water (mass number: 18) released from the BaSrMgAl₁₀O₁₇:Eu particles by heating from 500° C. to 1000° C. is 20% or less based on the weight of the total quantity of water released from these particles by heating from room temperature to lower than 500° C., and when the total quantity of water released from these particles by heating from 500° C. to higher than 500° C. is 80 wtppm or less (based on the weight of the blue phosphor).

8. The plasma display panel of claim 7, wherein the BaSrMgAl₁₀O₁₇:Eu particles have a coating containing silicon oxide or aluminum oxide, the coating has a substantially neutral polarity at its surface.

9. The plasma display panel of claim 8, wherein the ratio of Eu³⁺ to Ba and Sr is 1.5 to 4.5.

10. The plasma display panel of claim 7, wherein the ratio of Eu³⁺ to Ba and Sr is 1.5 to 2.8.

11. A plasma display panel comprising at least a blue phosphor layer and a green phosphor layer, the blue phosphor layer containing BaMgAl₁₀O₁₇:Eu particles, the green phosphor layer containing Zn₂SiO₄:Mn particles, Eu containing Eu³⁺, a ratio of Eu³⁺ to Ba at a surface of each BaMgAl₁₀O₁₇:Eu particle being 1.5 or more (atomic ratio: measured by XPS).

12. The plasma display panel of claim 11, wherein the BaMgAl₁₀O₁₇:Eu particles have a coating containing silicon oxide or aluminum oxide, the coating has a substantially neutral polarity at its surface.

13. The plasma display panel of claim 12, wherein the ratio of Eu³⁺ to Ba is 1.5 to 4.5.

14. The plasma display panel of claim 11, wherein the ratio of Eu³⁺ to Ba is 1.5 to 2.8.

15. A plasma display panel comprising at least a blue phosphor layer and a green phosphor layer, the blue phosphor layer containing BaSrMgAl₁₀O₁₇:Eu particles, the green phosphor layer containing Zn₂SiO₄:Mn particles, Eu containing Eu³⁺, a ratio of Eu³⁺ to Ba and Sr at a surface of each BaSrMgAl₁₀O₁₇:Eu particle being 1.5 or more (atomic ratio: measured by XPS).

16. The plasma display panel of claim 15, wherein the BaSrMgAl₁₀O₁₇:Eu particles each have a coating containing silicon oxide or aluminum oxide, the coating has a substantially neutral polarity at its surface.

17. The plasma display panel of claim 16, wherein the ratio of Eu³⁺ to Ba and Sr is 1.5 to 4.5.

18. The plasma display panel of claim 15, wherein the ratio of Eu³⁺ to Ba and Sr is 1.5 to 2.8.
